(19) United States
(12) Patent Application Publication
(10) Pub. No.: US 2025/0010538 A1
(43) Pub. Date: Jan. 9, 2025

(54) Stretching Device and Method for Monoaxial Stretching of a Film Web in the Transport Direction Thereof

(71) Applicant: Windmöller & Hölscher KG, Lengerich (DE)

(72) Inventors: Fabian Fischer, Lengerich (DE); Marc Münnich, Lengerich (DE); Ingo Rübbelke, Lengerich (DE)

(21) Appl. No.: 18/710,784

(22) PCT Filed: Nov. 11, 2022
(86) PCT No.: PCT/EP2022/081608

§ 371 Date: Jun. 7, 2024

(30) Foreign Application Priority Data
Nov. 18, 2021 (DE) 10 2021 212 962.5

(51) Int. Cl. B29C 55/06

(52) U.S. Cl. CPC B29C 55/06

(57) ABSTRACT

The invention relates to a stretching device for monoaxial stretching of a film web in the transport direction thereof, the stretching device comprising: a first roll (holding roll), via which the film web can be guided and which rotates at a first circumferential speed; a second roll (stretching roll), which is arranged downstream of the first roll and via which the film web can be guided and which rotates at a second circumferential speed; wherein the second circumferential speed is greater than the first circumferential speed; wherein at least one clamping roll is provided, by means of which the film web can be pressed against one of the rolls. At least one holding assembly is provided, relative to which the clamping roll is rotatable, wherein the clamping roll is supported on the holding assembly by a support point extending over part of, in particular over more than a quarter of, the axial length, or by a plurality of support points distributed over the axial length of the clamping roll and/or the circumference of the clamping roll.

The invention relates to a stretching device for monoaxial stretching of a film web in the transport direction thereof according to claim 1 and to the method according to claim 19.

Generic stretching devices, which are often arranged inline, particularly in or downstream of a blown film line, have been in use for a long time. Such a stretching device comprises at least one first roller, which can also be referred to as a holding roller, over which the film web can be guided and which rotates at a first circumferential speed. Downstream of the first roller is a second roller, which can also be referred to as a stretching roller and over which the film web can be guided after it has left the first roller. The second roller rotates at a second circumferential speed, this second circumferential speed being greater than the first circumferential speed. In the stretching section in which the film web has already left the first roller but has not yet reached the second roller, the film is stretched in its transport direction. This section is often referred to as the stretching gap. In addition, the first and second rollers usually rotate in opposite directions so that the film web is guided over each of the two rollers with the largest possible wrap angle. Overall, important properties of the film web are specifically changed with the described stretching process.

However, the undesirable phenomenon of neck-in also occurs with this stretch, in which the film web becomes narrower than its original width. In addition, the edges of the film web thicken, resulting in an uneven thickness profile in the transverse direction. The edges must therefore be cut off so that the usable width of the film web is reduced. The cut edges, on the other hand, cannot be used and therefore cause undesirable costs. In order to reduce these effects, many improvements have been proposed in the past. One measure is the provision of at least one pressure roller with which the film web can be pressed against one of the rollers. In particular, at least one pressure roller is provided on both the first roller and the second roller. In particular, when a pressure roller presses the film web at its release line from the first roller and/or a pressure roller presses the film web at its impact line on the second roller, the neck-in is already reduced. It turns out that the actual release line or impact line does not match the ideal paths, which run parallel to the axial direction of the first or second roller. The deviation between the ideal and actual line is reduced by the pressure rollers.

However, there is an ongoing need to further reduce the neck-in in order to reduce unwanted costs.

The task is therefore to propose a stretching device and a method with which the above-mentioned requirements can be better met.

The foregoing problem is solved by a stretching device having the features of claim 1 and a method having the features of claim 19. Further features and details of the invention are apparent from the subclaims, the description and the drawings. Features and details which are described in connection with the method according to the invention naturally also apply in connection with the stretching device according to the invention and vice versa, so that reference is or can always be made to the individual aspects of the invention with respect to the disclosure.

The invention is based on the realization that even a conventional pressure roller does not run along its ideal line, but is subject to deflection. The invention now improves this situation in that at least one holding arrangement is provided, relative to which the pressure roller can be rotated, the pressure roller being supported on the holding arrangement via a support point extending over a part, in particular over more than a quarter, of the axial length of the pressure roller or via a plurality of support points distributed over the axial length of the pressure roller and/or the circumference of the pressure roller.

With these measures, it is possible to absorb the forces acting on the pressure roller by means of a holding arrangement that is further away from the first and/or second roller in the radial direction. The space available here can now be used to design the holding arrangement with a high bending stiffness.

Conversely or additionally, it is thus possible to reduce the diameter of the pressure roller compared to the prior art. A reduced diameter of the pressure roller means that the stretching gap is or can be reduced and the pressure roller is still positioned at the release line or the impact line. A reduced stretching gap is advantageous, as this further reduces the neck-in effect. It can be advantageous if several pressure rollers are assigned to at least one of the rollers.

The invention also makes it possible for the film web to run over the pressure roller with a wrap angle. The force exerted by the film web on the pressure roller in this case can easily be compensated by the design according to the invention. It is advantageous if the film web wraps around the pressure roller with a wrap angle of between 0° and 90°. In particular, the wrap angle is between 0.1° and 90°, preferably between 0.5° and 90°.

With the aforementioned measure, the stretching gap can be further reduced to reduce the neck-in.

It is advantageously provided for each pressure roller to be rotatably mounted at its ends in holders of the holding arrangement, whereby in particular it is also provided for the pressure rollers to be displaceable relative to the holders in the radial direction of the pressure roller.

Preferably, a holding arrangement is assigned to each pressure roller.

The holding arrangement is preferably supported on the machine frame in which the first and/or second roller is also supported.

It is also advantageous if each support point of the at least one pressure roller is arranged on at least one carrier, which extends in particular over the longitudinal direction of the pressure roller. This carrier essentially provides the required supporting force for the supporting elements and thus for the pressure roller. The carrier can be designed as a single piece, but can also be made up of individual carrier pieces. This enables a modular design of the carrier, in which the carrier can be assembled from a different number of carrier pieces depending on the working width of the stretching device, which in particular reduces the manufacturing costs of the stretching device.

In an advantageous embodiment of the invention, the at least one support point comprises at least one roller, on the circumferential surface of which the pressure roller rolls. In particular, each support point comprises several rollers. The roller is in turn supported on the holding arrangement. With such a roller, the friction of the pressure roller is reduced so that its surface remains as undamaged as possible.

In a further development, it is provided that the at least one support point comprises at least one roller which is mounted on an axle via at least one bearing, the axle being attached to the holding arrangement, in particular to a carrier of the holding arrangement, by means of an axle carrier. In particular, it is intended that the roller is rotatably supported on the axle via ball, roller or needle bearings. Such bearings can also withstand relatively large forces, which are necessary for supporting a pressure roller in a stretching device. In particular, each axle is attached to the holding arrangement at both ends by means of an axle carrier. An axle carrier can be a common axle carrier for two adjacent axles. Furthermore, axle carriers can be distributed over the axial length of an axle. A separate axle can be provided for each roller, but it is advantageous to provide at least two rollers on each axle. Instead of a plurality of rollers, elongated rollers whose axial length is greater than their outer diameter can also be provided.

Alternatively or additionally, it is advantageous if the at least one support point comprises at least one roller, each roller being attached to a shaft, the shaft being rotatably mounted on a shaft bearing, which in turn is attached to a carrier of the holding arrangement. The embodiments described above in relation to the axles can also be transferred analogously to the shaft arrangement.

The rollers disclosed in the aforementioned embodiments can be provided in various configurations. For example, in order to reduce the friction between a roller and a pressure roller, it may be intended to provide the roller with a smooth circumferential surface, i.e. the surface on which the pressure roller rolls. This can be achieved, for example, by chrome-plating the roller surface. In this context, it can be advantageous to avoid damage if the circumferential surface is hard or rigid, which can be achieved in particular by a circumferential surface comprising a metal. A hard or rigid circumferential surface and/or a smooth circumferential surface are particularly advantageous if the pressure roller comprises a soft circumferential surface.

It may further be provided that the circumferential surface of at least one roller comprises a structure. A structure means that there are indentations on the circumferential surface. Such a structure may be regular, for example comprising grooves and/or holes. Such a regular structure is therefore created in particular by machining or manufacturing the circumferential surface with a tool, in particular by contact machining. Additionally or alternatively, irregular structuring of the circumferential surface of the at least one roller may be provided. Such irregular structuring can be achieved in particular by projectile blasting of the circumferential surface, as is the case with sandblasting or glass bead blasting. A structure with indentations serves primarily to absorb the air introduced into the roller/roller gap by the pressure roller and thereby prevent contact breakage between the roller and the pressure roller.

However, a circumferential surface of the at least one roller can also serve to prevent contact breakage, whereby the circumferential surface comprises an elastomeric material. This means that the circumferential surface is flexible.

In general, the circumferential surface quality can be made dependent on that of the roller, i.e. the holding roller and/or the stretching roller. If the roller comprises a flexible circumferential surface, in particular due to an at least partially elastomeric coating, an assigned pressure roller can comprise a very hard circumferential surface, for example if this comprises a polished steel. In this case, it is preferred that the roller at least partially comprises a flexible circumferential surface.

The circumferential surface of the at least one roller can be concave, i.e. it has a larger diameter at its edges in the direction of its axis of rotation than in the center. Alternatively, the circumferential surface can be convex. A concave or convex circumferential surface can reduce the contact area between the pressure roller and the roller and thus the surface wear.

In the context of the present invention, a roller is also to be understood as a sleeve in which, in particular, the axial length is greater than the diameter.

In an advantageous embodiment of the invention, at least two rows of support points or at least two support points are provided, which are each arranged at different angular positions in the circumferential direction of the pressure roller. In this way, the pressure roller runs in a channel-like indentation, which can also be referred to as a roller bed. The pressure roller is thus supported at different points so that the pressure force provided by the holding arrangement is better distributed on the outer circumference of the pressure roller. This measure also makes it easier to hold the pressure roller in position.

It is also advantageous if a first row and at least one second row of support points are provided, the rows extending in the longitudinal direction of the pressure roller, the support points comprising rollers, at least one roller of the first row being arranged offset relative to the at least one roller of the second row in the longitudinal direction of the pressure roller. In particular, it is provided that at least one roller runs on each circumferential piece of the pressure roller in the longitudinal direction of the rollers. There is therefore essentially no surface element of the pressure roller on which there is no contact with a roller during rotation. The advantage of this arrangement is that the surface of the pressure roller wears very evenly and the surface remains very smooth. In addition, any deposits that occur when outgassing molecules are deposited from the film web are removed evenly by the rollers. This effect can be further improved if two adjacent rollers, which are offset in the circumferential direction of the pressure roller, have an overlap. This means that there can be sections on the pressure roller that are contacted by two rollers.

In a further advantageous embodiment of the invention, the support point comprises at least one concave channel element in which the pressure roller lies, the inner surface of the channel element being provided with openings through which a pressurized fluid can be conducted into the region between the channel element and the pressure roller. This fluid is preferably a gas, in particular air. With this measure, the pressure roller can therefore be held by the support point without contact and guided during rotation. This results in a “floating bearing” of the pressure roller. The channel element can be an elongated shell made of a plastic, a fiber-reinforced plastic or a metal. The openings on the inner surface, the radius of which is preferably only slightly larger than the outer radius of the pressure roller, can be connected to supply lines, such as through-holes, so that the pressurized fluid (higher pressure than the ambient pressure) can be easily supplied from the outside. In order to achieve a better distribution of the fluid between the inner surface and the outer surface of the pressure roller, the inner surface of the channel element can be covered or coated with a fine-pored material, such as sintered plastic and/or sintered metal. It is also possible to form the channel element exclusively with a sintered material.

In order to now apply a force to the pressure roller against the at least one support point, at least one traction device is provided, with which a force can be provided, which can act on the pressure roller and which acts in the direction of the holding arrangement and in particular in the radial direction of the pressure roller. Even if end holders are provided for the pressure roller, as described above, such a traction device is advantageous in order to hold the pressure roller over its entire length at or in the at least one support point. This is particularly important when the not yet rotating pressure roller is brought into contact with the first and/or second roller, which is already rotating, or with the film web. The traction device now prevents the pressure roller from jumping out of the support point or jamming with the support point.

It is particularly advantageous if at least one traction device is provided, with which a force directed in the direction of the holding arrangement can act on the pressure roller, the traction device comprising at least one magnet and at least one magnetizable element. The magnet is arranged in or on the holding arrangement and the magnetizable element is arranged in or on the pressure roller and/or in or on the holding arrangement. In other words, in order to generate an attractive magnetic force, one element must be partially magnetizable and the second element must carry at least one magnet. The magnet is preferably a permanent magnet, but can also be a switchable electromagnet.

Alternatively or additionally, it is advantageous if at least one traction device is provided, with which a force directed in the direction of the holding arrangement can act on the pressure roller, the traction device comprising at least one suction device arranged on the holding arrangement, with which the pressure roller can be acted upon by a suction force acting in the direction of the holding arrangement. A suction device can, for example, be a bore, a hose, a tube or similar, one end of which is located in the direct vicinity of the pressure roller and the other end of which is connected to a vacuum generator, such as a blower or a vacuum pump. The advantage of using such a suction device to generate the traction force is that the magnitude of the traction force can be varied.

In a further, advantageous embodiment of the invention, at least one shifting drive is provided, with which the pressure roller can be moved back and forth in its axial direction. In particular, it is provided that the shifting takes place periodically, which can be realized in a simple manner. It is provided that the pressure roller is mounted so as to be longitudinally displaceable relative to the end holders of the holding arrangement. The shifting drive can be arranged on the holding arrangement. A double-acting and compressed air-operated piston-cylinder unit is a suitable drive. A permanently rotating motor is also conceivable, whose rotational movement is converted into a linear movement via a wheel and a coupling rod, for example. Finally, a servo motor or a linear motor is also conceivable. A shifting of the pressure roller has the effect that the wear of the surface is evened out and/or deposits or soiling do not build up at certain points and ultimately lead to damage to the film web.

Furthermore, it is advantageous if at least one cleaning element is arranged on the holding arrangement, in particular on the carrier of the holding arrangement, with which the outer surface of the pressure roller can be cleaned. Such a cleaning element can, for example, be a cloth, felt piece or similar extending at least partially over the length of the pressure roller, which in particular permanently contacts the pressure roller. However, the cleaning element can also be a polishing element that is attached to a carriage. This carriage can be moved along a guide, which is preferably attached to the carrier, in the axial direction of the pressure roller. This allows the surface of the pressure roller to be cleaned by moving the carriage continuously or as required. The carriage can also be moved beyond at least one end of the pressure roller in order to be able to change or clean the polishing element itself. Polishing the pressure roller in turn has the advantage that no deposits or soiling will build up that could damage the film web.

It is also preferable if the outer surface of the pressure roller is provided with a coating, in particular a rubber coating. The coating is advantageously made of a compressible material so that the film web experiences sufficient static friction.

It is also advantageous if the pressure roller can be driven in rotation by a drive. In other words, a drive is provided with which the pressure roller can be set in rotation or stopped. This drive can be a known electric motor or an air motor. The advantage is that the pressure roller can already be set in rotation before it is placed on an already moving foil web. On the one hand, this reduces wear on the pressure roller and, on the other hand, damage to the film web is avoided when the pressure roller is positioned. It is also advantageous if the pressure roller can be pressed against the roller in an angular range which is at most +/−30 degrees around the line on the roller which is defined by the common tangential plane of both rollers. For this purpose, it is provided that the holding arrangement is mounted so as to be movable relative to the roller, the holding arrangement being movable at least in the circumferential direction of the at least one roller. In particular, it is advantageous if the pressure roller can be moved beyond the said line as seen in the transport direction of the film web. In this case, the film web does not leave or touch the roller at the release line or the impact lines, but afterwards or before. Specifically, this means that in the case of the holding roller, the film web first runs on the pressure roller and in the case of the stretching roller, it first runs on the pressure roller before it hits the stretching roller. In this case, the stretching gap can be shortened again so that the neck-in is further reduced.

In a further embodiment of the invention, it is provided that at least two holding arrangements are provided for the holding roller and/or for the stretching roller, the two holding arrangements being connected to one another via connecting elements. A total of two holding arrangements can thus be provided per roller, the two holding arrangements being fastened to a connecting element. The dimensions of the connecting element are such that the pressure roller of the first holding arrangement presses the film web against the roller in the area of its impact line and that the pressure roller of the second holding arrangement presses the film web against the roller in the area of the release line. The connecting element can be movable relative to the relevant roller in the circumferential direction and/or in the radial direction by means of at least one adjusting mechanism, so that the pressure rollers can also be moved with the movement of the connecting element. To move the connecting element, the adjusting element preferably comprises at least one air-operated piston-cylinder unit. It is preferable that the connecting element is supported on the machine frame on which the relevant roller is also supported. If two holding arrangements, which are connected to each other via a connecting element, can be positioned on different lines of the relevant roller, this results in an increased positioning force, as the connecting element, which is particularly rigid, also contributes to a normal force in the radial direction of the roller. Overall, the film web is thus pressed even more strongly against the roller at a given positioning force, so that the neck-in can be further reduced. It is particularly preferable if two holding arrangements and one connecting element each are assigned to both the holding roller and the stretching roller.

The stretching device described above and the advantageous embodiments can be provided within any film manufacturing or film processing line. In particular, the stretching device according to the invention can be provided inline within a blown film line or a flat film line. In a blown film line, for example, the stretching device can be provided in the transport direction of the film web between a flattening device and a reversing device or downstream of the reversing device, but upstream of a winding device. In a blown film line, the film web can also be a two-layer film web that has been folded together from a film bubble. The two layers of the film web can then be joined together at both side edges or only at one side edge, or separated from each other by being cut open on both sides beforehand.

The above task is additionally solved by a method for monoaxial stretching of a film web in the transport direction thereof,
whereby the film web is guided over a first roller (holding roller), which rotates at a first circumferential speed,
whereby the film web is guided over a second roller (stretching roller) arranged downstream of the first roller, which rotates at a second circumferential speed,
whereby the second circumferential speed is greater than the first circumferential speed,
whereby the film web is pressed against one of the rollers by at least one pressure roller.

The invention is characterized in that at least one holding arrangement is provided, relative to which the pressure roller rotates, the pressure roller being supported on the holding arrangement via a support point extending over more than a quarter of the axial length or via a plurality of support points distributed over the axial length of the pressure roller and/or the circumference of the pressure roller.

The same advantages that have already been described above in connection with the stretching device according to the invention can thus be achieved.

Further advantages, features and details of the invention are shown in the following description, in which various embodiments are explained in detail with reference to the figures. The features mentioned in the claims and in the description can each be essential to the invention individually or in any combination of mentioned features. In the context of the entire disclosure, features and details which are described in connection with the method according to the invention naturally also apply in connection with the stretching device according to the invention and vice versa in each case, so that reference is or can always be made reciprocally with respect to the disclosure to the individual aspects of the invention. The individual figures show:

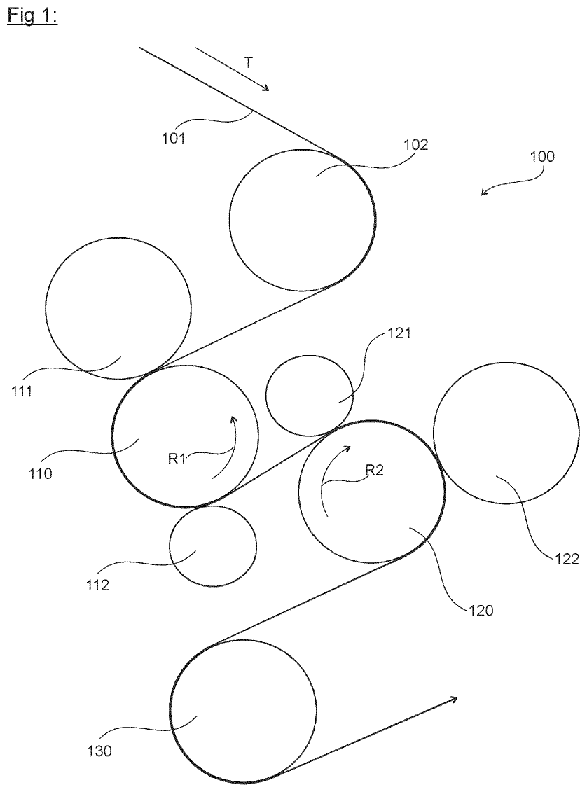

FIG. 1 Schematic representation of a stretching device according to the invention

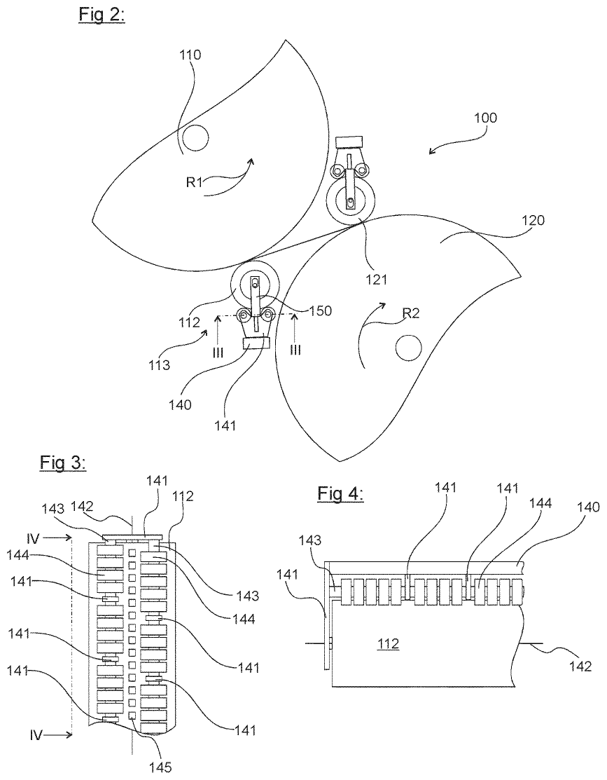

FIG. 2 Illustration of further details of the stretching device according to the invention

FIG. 3 View Ill-III from FIG. 2

FIG. 4 View IV-IV from FIG. 3

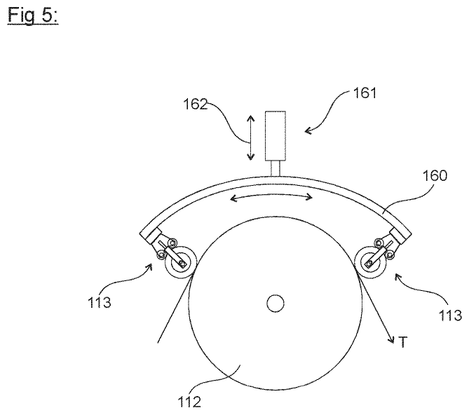

FIG. 5 Representation of a further development of stretching device according to the invention.

FIG. 1 shows a schematic representation of a stretching device according to the invention. The film web 101 runs into the stretching device 100 in the transport direction T. The film web first runs onto one or more preheating rollers, of which only one preheating roller 102 is shown. A preheating roller has the task of bringing the film to a predefined temperature. For this purpose, a preheating roller is usually tempered, whereby a tempered fluid is often introduced into the preheating roller.

After leaving the preheating roller(s) 102, the film web 101 passes onto a first roller 110, which can generally also be referred to as a holding roller 110. This holding roller can be connected to a drive which is not shown, for example a separate electric motor which drives the roller 110 to rotate at a first circumferential speed. Additionally or alternatively, a braking device may be provided.

The first roller 110 is preferably assigned a first pressure roller 111 which, together with the first roller 110, provides an infeed gap for the film. Preferably, the infeed gap or the path of the film web 101 is arranged in such a way that the film web 101 runs tangentially to the rollers 110, 111 in the infeed gap. The roller gap already serves to minimize the air between the holding roller 110 and the film.

A second pressure roller 112, which forms an outfeed gap with the roller 110, is associated with the first roller 110. The second pressure roller 112 can be adjustable in the circumferential direction and/or in the radial direction of the first roller 110. The second pressure roller 112 serves to ensure that the film leaves the first roller 110 along a line which runs parallel to the axial direction of the first roller 110.

Viewed in the transport direction T of the film 101, a second roller 120 is arranged downstream, which can be referred to as stretching roller 120. The stretching roller 120 is connected to a further drive not shown, for example a separate electric motor, which drives the roller 120 to rotate at a second circumferential speed. The directions of rotation R1 of roller 110 and R2 of roller 120 are in opposite directions. This ensures that the film web has the largest possible wrap angle around each roller 110, 120. The second circumferential speed is greater than the first circumferential speed, whereby the stretching roller 120 then has a greater circumferential speed than the holding roller 110. This results in the film 101 being stretched in its transport direction between the outfeed gap of the first roller 110 and the infeed edge of the second roller 120 in the ratio of the circumferential speeds. The distance between the outfeed gap and the infeed edge is often referred to as the stretching gap.

It is possible that the first roller 110 and the second roller 120 can be moved relative to each other. This allows the stretching gap to be influenced. A change in the stretching gap can influence the properties of the film. It is preferable to have the smallest possible stretching gap, i.e. the shortest possible distance between the rollers 110 and 120, in which the film web is freely guided.

The second roller 120 is preferably associated with a third pressure roller 121 which, together with the second roller 120, provides a second infeed gap for the film. Preferably, the infeed gap or the path of the film 101 is arranged in such a way that the film 101 runs tangentially to the rollers 120, 121 in the infeed gap. The roller gap already serves to minimize the air between the stretching roller 120 and the film, so that the friction between the film web and the roller 120 is minimized.

In the event that the stretching gap is small, the third pressure roller 121 would collide with the roller 110, so that in this case the third pressure roller would have to be swung off.

The second roller 120 is also optionally associated with a fourth pressure roller 122, which forms an outfeed gap with the roller 120. The fourth pressure roller 122 can also be adjustable in the circumferential direction of the second roller 120. The fourth pressure roller 122 serves to ensure that the film leaves the second roller 120 along a line that runs parallel to the axial direction of the roller 120.

In principle, one or more pressure rollers can also be dispensed with in a stretching device according to the invention. Nevertheless, there may be an infeed gap or outfeed gap. This is then to be understood as the line along which the film is applied to the holding or stretching roller or at which the film is released from the holding or stretching roller.

Further rollers, in particular with one or two pressure rollers each, can be provided, whereby two rollers arranged directly one after the other are driven in such a way that the roller arranged downstream has a higher circumferential speed than the preceding roller.

A cooling roller 130 is arranged downstream of the rollers 110, 120, with which the film web 101 can be cooled again, so that the new molecular orientation within the film web resulting from the stretching solidifies.

FIG. 2 shows further details of the stretching device 100 according to the invention. In addition to the holding roller 110 and the stretching roller 120, the second pressure roller 112 and the third pressure roller 121 are shown.

The second pressure roller 112 and/or the third pressure roller 121 are preferably supported on a carrier 140, in particular a transverse carrier, which runs transversely to the transport direction of the film web. The carrier in turn is supported directly or indirectly on the machine frame, on which the roller or rollers are also supported. The carrier itself can consist of several individual pieces joined together. As the roller or rollers can be movable relative to the machine frame, movement devices such as swivel bearings or slide-rail combinations can be provided between the machine frame and the rollers. The carriers can also be supported on these movement devices, whereby the carriers and thus the pressure rollers can be separately movable relative to the movement devices in order to be able to move the pressure rollers relative to the first and/or the second roller. The manner in which the pressure rollers are supported on the carriers is described below by means of an embodiment, whereby the invention is not limited to this embodiment.

The further, preferred embodiment of a holding arrangement 113 for a pressure roller is now described by way of example for the pressure roller 112, but is of course valid for all other pressure rollers. FIGS. 3 and 4 show further views of the holding arrangement, to which reference is also made in the following description.

Several holders 141 are connected to the carrier 140, which are distributed over the longitudinal direction of the carrier and thus over the axial direction of the pressure roller. The axial direction is shown by the representation of the axis of rotation 142 of the pressure roller. Each holder carries an axle 143, whereby a separate axle can be provided between every two holders or an axle can extend through several holders. Alternatively, shafts can be provided instead of axles, which are then rotatably mounted in the holders, so that the following description in relation to the axles also applies to shafts. The axle between two holders is also referred to below as the axle section.

A first and at least a second axle or a first and at least a second row of axles are provided, which extend parallel to each other and parallel to the axial direction of the pressure roller. Each axle carries one or more rollers 144, which are rotatably mounted on the axle. In the case of shafts, these rollers 144 can be fixedly connected to the shaft. Thus, the rollers 144 are also distributed along the axles in the axial direction of the pressure roller. During operation, the pressure roller 112 rolls on these rollers, so that these are components of the support device via which the pressure roller is supported on the holding arrangement. A group of rollers can be provided for each axle or axle section. It is advantageous if axle sections of the first axle or axle row are arranged offset in the axial direction to at least one axle section of the second axle or axle row in order to avoid localized soiling or wear, which would otherwise occur due to uneven rolling of the rollers on the pressure roller.

The two parallel axles or rows of axles together with their rollers form a recess in which the pressure roller lies, so that any movement other than the intended rotational movement is avoided. The pressure roller 112 itself can be rotatably mounted in the front-side holders 141 or in extension pieces 150 of these holders via a pivot bearing. The pivot bearing can be displaceably arranged in the holder or its attachment piece in order to reduce any radial forces on the pivot bearing in the event of varying pressure forces. This displaceability can be realized, for example, by means of slotted holes in the attachment pieces 150, in which the pivot bearings are displaceably arranged.

In order to be able to keep the pressure roller always in contact with the rollers 144, several magnets 145 can be arranged directly or indirectly on the carrier in the axial direction over the length of the pressure roller. In this embodiment, the pressure roller comprises in its body at least one magnetizable element, preferably an iron core extending in the axial direction, which is attracted by the magnets, which are preferably permanent magnets, via a magnetic force. The magnetizable element inside the pressure roller is not shown.

Overall, the arrangement described in connection with FIGS. 2 to 4 reduces the deflection of the pressure roller. This makes it possible, on the one hand, to increase the pressure force of the pressure roller on the roller 110 and/or 120 and/or to shorten the stretching gap. Both options lead to a reduction in the neck-in effect and therefore to more cost-effective production of a marketable film web.

FIG. 5 now shows an advantageous further development of the stretching device according to the invention. Two holding arrangements for two pressure rollers are shown, preferably as shown in FIGS. 2 to 4, whereby one pressure roller is associated with the contact line of the film web on the roller and the second pressure roller is associated with the release line. Both holding arrangements are connected to each other 10 via a connecting element 160. The connecting element offers the advantage that both holding arrangements together with the pressure rollers can be moved relative to the roller 112 by means of a common adjusting device 161. The adjustment device can, for example, comprise a piston cylinder unit operated by compressed air, with which the connecting element can be adjusted in the radial direction of the roller 112 (shown by the double arrow 162). For an adjustment in the circumferential direction of the roller 112, the connecting element 160 can be arranged displaceably on the adjusting device 161. It is also conceivable that the adjusting device is pivotably arranged on the machine frame or on a bracket carrying the roller 112.

List of reference numbers

| | |
|---|---|
| 100 | Stretching device |
| 101 | Film web sheet |
| 102 | Preheating roller |
| 110 | First roller; holding roller |
| 111 | First pressure roller |
| 112 | Second pressure roller |
| 113 | Holding arrangement |
| 120 | Second roller; stretching roller |
| 121 | Third pressure roller |
| 122 | Fourth pressure roller |
| 130 | Cooling roller |
| 140 | Carrier |
| 141 | Holder |
| 142 | Rotary axis |
| 143 | Axle |
| 144 | Rollers |
| 145 | Magnet |
| 150 | Attachment pieces |
| 160 | Connecting element |
| 161 | Adjusting device |
| 162 | Double arrow to show the radial direction |
| T | Transport direction |
| R1 | Rotation direction of roller 110 |
| R2 | Rotation direction of roller 120 |

1. Stretching device for monoaxial stretching of a film web in the transport direction thereof, having a first roller (holding roller) over which the film web can be guided and which rotates at a first circumferential speed, a second roller (stretching roller) which is arranged downstream of the first roller, over which the film web can be guided, and which rotates at a second circumferential speed, the second circumferential speed being greater than the first circumferential speed, at least one pressure roller being provided, with which the film web can be pressed against one of the rollers, characterized in that
at least one holding arrangement is provided, relative to which the pressure roller can be rotated, the pressure roller being supported on the holding arrangement via a support point extending over part, in particular over more than a quarter, of the axial length of the pressure roller or via a plurality of support points distributed over the axial length of the pressure roller and/or the circumference of the pressure roller.

2. Stretching device according to claim 1,
characterized in that
each support point is arranged on at least one carrier which extends essentially over the length of the pressure roller.

3. Stretching device according to claim 1,
characterized in that
at least one support point comprises at least one roller, on the circumferential surfaces of which the pressure roller rolls.

4. Stretching device according to claim 1,
characterized in that
at least one support point comprises at least one roller which is mounted on an axle via at least one bearing, the axles being fastened to the holding arrangement by means of an axle carrier.

5. Stretching device according to claim 4,
characterized in that
the axles are attached to a support of the holding device by means of the axle carrier.

6. Stretching device according to claim 1,
characterized in that
at least one support point comprises at least one roller, each roller being fastened on a shaft, the shaft being rotatably mounted on a shaft bearing, which in turn is fastened to a carrier of the holding arrangement.

7. Stretching device according to claim 1,
characterized in that
at least two rows of support points or at least two support points are provided, which are arranged at different angular positions in the circumferential direction of the pressure roller.

8. Stretching device according to claim 1,
characterized in that
a first row and at least one second row of support points are provided, the rows extending in the longitudinal direction of the pressure roller, the support points comprising rollers, at least one roller of the first row being arranged offset relative to at least one roller of the second row in the longitudinal direction of the pressure roller.

9. Stretching device according to claim 1,
characterized in that
the support point comprises at least one concavely shaped channel element in which the pressure roller lies, the inner surface of the channel element being provided with openings through which a fluid under excess pressure can be conducted into the region between the channel element and the pressure roller.

10. Stretching device according to claim 1,
characterized in that
at least one traction device is provided, with which a force can be applied to the pressure roller, which force is directed in the direction of the holding arrangement.

11. Stretching device according to claim 1,
characterized in that
at least one traction device is provided, with which a force can be applied to the pressure roller, which force is directed in the direction of the holding arrangement, the traction device comprising at least one magnet and at least one magnetizable element, the magnet being arranged in or on the holding arrangement and/or in or on the pressure roller and the magnetizable element being arranged in or on the pressure roller and/or in or on the holding arrangement.

12. Stretching device according to claim 2,
characterized in that
at least one traction device is provided, with which a force can be applied to the pressure roller, which force is directed in the direction of the holding arrangement, the traction device comprising at least one suction device arranged on the carrier, with which suction device the pressure roller can be acted upon by a suction force acting in the direction of the holding arrangement.

13. Stretching device according to claim 1,
characterized in that
at least one shifting drive is provided, with which the pressure roller can be moved back and forth in its axial direction.

14. Stretching device according to claim 2,
characterized in that
at least one cleaning element is arranged on the carrier, with which cleaning element the outer surface of the pressure roller and/or at least one support point and/or at least one roller can be cleaned.

15. Stretching device according to claim 1,
characterized in that
the pressure roller is provided with a coating, in particular a rubber coating, on its outer surface.

16. Stretching device according to claim 1,
characterized in that
the pressure roller can be driven in rotation by a drive.

17. Stretching device according to claim 1,
characterized in that
the pressure roller can be pressed against the roller in an angular range which is at most +/−30 degrees around the line on the roller which is defined by the common tangential plane of both rollers.

18. Stretching device according to claim 1,
characterized in that
the holding arrangement can be changed in position relative to the holding roller and/or relative to the stretching roller in their circumferential directions and/or in their radial directions.

19. Stretching device according to claim 1,
characterized in that
at least two holding arrangements are provided for the holding roller and/or for the stretching roller, the two holding arrangements being connected to one another via connecting elements.

20. Method for monoaxial stretching of a film web in the transport direction thereof,
the film web being guided over a first roller (holding roller) which rotates at a first circumferential speed, the film web being guided over a second roller (stretching roller) which is arranged downstream of the first roller and rotates at a second circumferential speed, the second circumferential speed being greater than the first circumferential speed, the film web being pressed against one of the rollers by means of at least one pressure roller, characterized in that
at least one holding arrangement is provided, relative to which the pressure roller rotates, whereby the pressure roller is supported on the holding arrangement via a support point extending over a part, in particular over more than a quarter, of the axial length of the pressure roller or via a plurality of support points distributed over the axial length of the pressure roller and/or the circumference of the pressure roller.
